(19) United States
(12) Patent Application Publication
(10) Pub. No.: US 2011/0238870 A1
(43) Pub. Date: Sep. 29, 2011

(54) Memory System With Command Filtering

(75) Inventors: Frederick A. Ware, Los Altos Hills, CA (US); Wayne Richardson, Saratoga, CA (US); Kishore Kasamsetty, Cupertino, CA (US)

(73) Assignee: Rambus Inc., Sunnyvale, CA (US)

(21) Appl. No.: 13/131,557

(22) PCT Filed: Nov. 17, 2009
(86) PCT No.: PCT/US09/64813

§ 371 Date: May 26, 2011

Related U.S. Application Data
(60) Provisional application No. 61/119,577, filed on Dec. 3, 2008.

(51) Int. Cl. G06F 13/28

(52) U.S. Cl. 710/35

(57) ABSTRACT

A memory system includes a memory controller coupled to at least one memory device via high-speed data and request links. The timing and voltage margins of the links are periodically calibrated to reduce bit error. The high-speed request links complicate calibration because commands issued over the uncalibrated request links can be erroneously interpreted by the memory device. Misinterpreted commands can disrupt the calibration procedure (e.g., a write command might be misinterpreted as a power-down command). The memory controller addresses this problem using a separate, low-speed control interface to issue a filter command that instructs the memory device to decline potentially disruptive requests when in a calibration mode.

### FIELD

The present disclosure relates to the calibration of high-speed request links between memory components.

### BACKGROUND

Typical memory systems include a memory controller that communicates with one or more memory device to store (write) and retrieve (read) data. The memory controller directs the reading and writing of data by issuing requests to the memory device via a request interface, which is also known as a “command and address” interface. Pursuant to these requests, data is moved between the memory controller and the memory device via a data interface.

Today's advanced computing systems and microprocessors demand greater and greater data bandwidths from memory systems. This demand has resulted in a concerted effort in the memory industry to increase the speed at which data are communicated between memory controllers and memory devices. One approach to improving the data bandwidth in memory systems has focused on designing high-speed interface structures.

High-speed memory interfaces convey information (e.g. requests or data) as a signal that varies with time to form a pattern representative of the information. A receiver of the signal reproduces the pattern, and therefore recovers the information, by periodically sampling the signal with respect to a reference voltage. The receiver must maintain the correct relationship between the received signal, the reference voltage, and the sample timing to correctly interpret the pattern. In high-speed systems, the margins for voltage and timing errors are very small, and are highly sensitive to physical and environmental variables. High-performance memory interfaces must therefore be carefully calibrated to optimize their voltage and timing margins.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 depicts a memory system 100 that includes an IC memory controller 105 connected to a single IC memory device (e.g. a DRAM die) 110 via a memory channel 112;

FIG. 2 is a flowchart 200 depicting a process for calibrating the DQ and RQ links of memory system 100 in accordance with one embodiment;

FIG. 3 details portions of system 100 of FIG. 1, two controller-side data interfaces 305 and 310 and the corresponding two memory-device-side data interfaces 315 and 320; and

FIG. 4 depicts the configuration process for an “even” write link of system 100 in the loop-back mode.

### DETAILED DESCRIPTION

This application describes advanced memory devices and systems equipped with multiple high-speed request (RQ) and data (DQ) links. The RQ links use point-to-point topology similar to that employed in the DQ links, which allows the RQ bandwidth to scale with DQ bandwidth. The timing and voltage margins of the high-speed DQ and RQ links are periodically calibrated to reduce error rates and improve speed performance. Relative to more common low-speed RQ links, the high-speed RQ links have far smaller voltage and timing margins. Before calibration, the error margins of the high-speed RQ links may be so low that the RQ links cannot be counted on to accurately communicate requests. For example, a memory controller could convey a pattern representative of a write request only to have the receiving memory device misinterpret the pattern, and thus the request. The RQ links must therefore be calibrated before the memory device can be trusted to correctly interpret requests.

The need to calibrate the RQ links to ensure correct request interpretation complicates the calibration process. This is because misinterpreted commands can disrupt the calibration procedure; for example, a write command misinterpreted as a power-down command could disable a memory device undergoing calibration. Described are calibration circuitry and methods that address this problem by selectively preventing the memory device from responding to potentially disruptive commands. In a calibration mode, for example, memory devices in accordance with some embodiments ignore a pre-defined set of disruptive requests. A proper request mistakenly identified as a disruptive request is, in a calibration mode, either ignored or converted into a safe request (i.e., “declined”). A received request interpreted to be a power-down command in the calibration mode might be converted into a no-operation command, for example. The figures focus on the routing of communications and the operation of the devices but often omit details that would otherwise clutter the description and occlude comprehension.

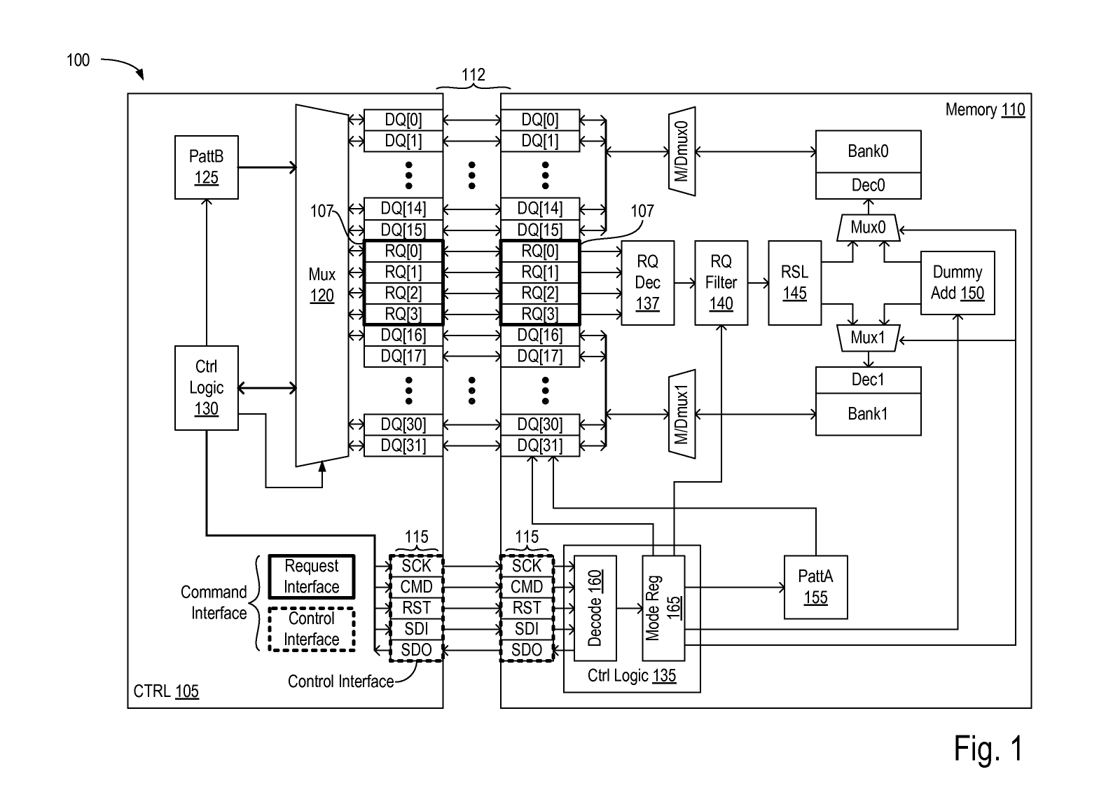

FIG. 1 depicts a memory system 100 that includes an IC memory controller 105 connected to a single IC memory device (e.g. a DRAM die) 110 via a memory channel 112. Controller 105 includes a data interface with thirty-two data links DQ[31:0], a request interface 107 with four request links RQ[3:0], and a serial control interface 115. Request interface 107 and control interface 115 both issue commands, albeit at different data rates, and so are collectively referred to herein as the “command interface.” In this embodiment the request links operate at the same rate as the DQ links. Control interface 115, a conventional serial command interface in this example, provides much lower speed performance than the data and command interfaces. Interface 115 supports relatively higher error margins, however, and therefore affords controller logic 130 a robust communication channel to communicate with memory 110 before the high-speed links are calibrated.

Channel 112 couples each link of controller 100 to a corresponding (and similarly labeled) link in memory 110. The data interface on memory 110 is coupled to a pair of memory banks Bank0 and Bank1 via respective multiplexers/demultiplexers M/Dmux0 and M/Dmux1. Each bank Bank0/1 includes a collection of storage cells and associated data, command, and address interfaces (not shown), and a respective row/column address decoder Dec0/1. The request interface on memory 110 communicates with the memory banks Bank0/1 via a request path that is modified in accordance with the depicted embodiment to filter out potentially harmful or disruptive commands during calibration. The request path includes a request decoder 137, a request filter 140, and request switching logic 145 to select between the two banks. A pair of multiplexers Mux0/1 allows control logic 135 to alternatively apply requests from steering logic 145 or dummy commands and/or dummy addresses from a dummy-address generator 150. A pattern generator 155 allows memory 110 to feed pseudo-random bit streams to controller 105 via each request and data link during calibration. Pattern generators 155 and 125 may be e.g. linear-feedback shift registers (LFSRs).

Exercising memory 110 for test and calibration requires controller 105 to issue read and write commands over request links RQ[3:0]. These exercises explore error margins for the request and data signals by purposefully advancing and retarding signal phases to deliberately introduce errors. Request errors so induced can be relatively harmless. For example, a read command with an erroneous address will simply read from the wrong memory location. The resulting error can be used to better calibrate system 100. Other misinterpretations can be troublesome, however. For example, a read or write command incorrectly interpreted as directing memory 110 to power down, or to refresh the memory cells, would disrupt the calibration procedure. Controller 105 is therefore able to instruct filter 140 to selectively decline potentially harmful commands during calibration.

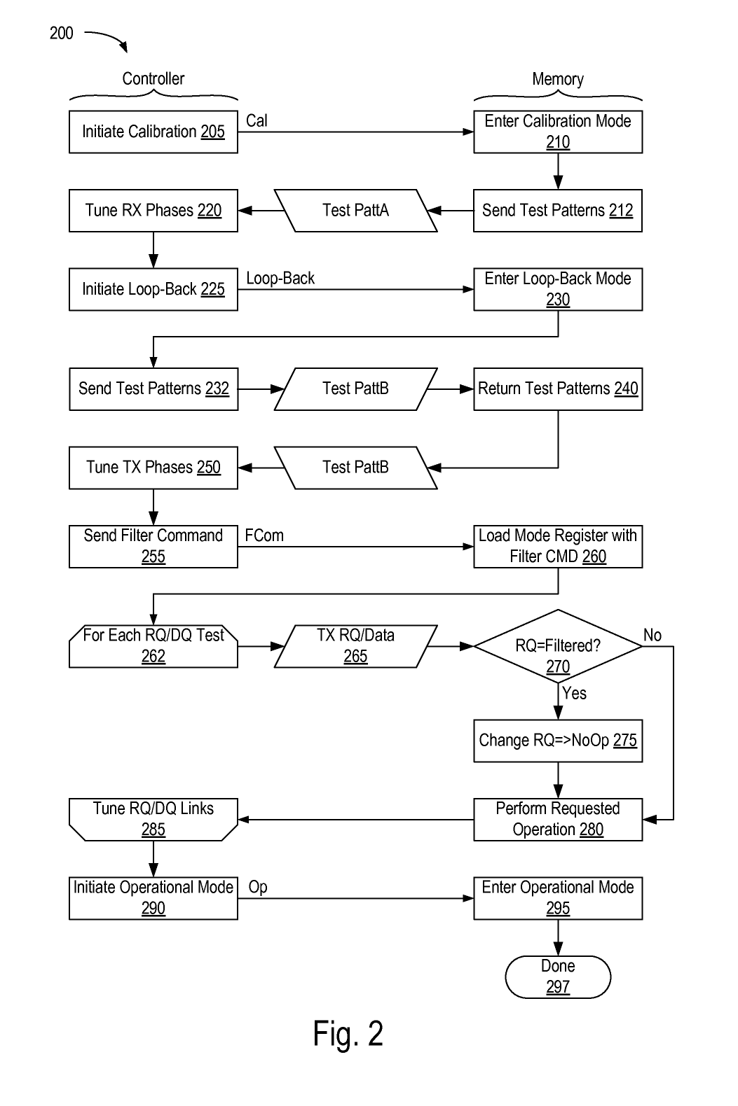

Returning to the controller side, a multiplexer 120 couples the data and request links to either of a pattern generator 125 or controller logic 130 at the direction of the controller logic. Pattern generator 125 is used for calibration, as described below in connection with FIG. 2. The RST, SCK, and CMD pins of control interface 115 connect to control logic 135 on memory 110. These pins supply the data, address, and control information to a decoder 160, which in turn writes appropriate commands to mode registers 165. The read data for these registers is accessed through the SDO/SDI pins. Interface 115 is of a well-known variety, so a detailed treatment is omitted. With the exception of its support for the calibration schemes disclosed herein, controller logic 130 and memory 110 may likewise be conventional. A detailed discussion of controller logic 130 and most elements of memory 110 is therefore omitted for brevity.

RQ links in accordance with some embodiments operate at speeds at or approaching the speed of the DQ links. RQ links that operate at high link rates may require careful calibration to maximize their timing and voltage margins. The following disclosure and supporting figures detail calibration methods and circuits that can be used to ensure the high-speed request links provide suitably low bit-error rates. The initial calibration involves two components that can occur separately or together: fine calibration and coarse calibration. Fine calibration aligns received request and data streams with their corresponding receive clock signals, whereas coarse calibration, also called “bit alignment,” synchronizes the receiving circuitry with the bit boundaries the transmitted request and data streams.

FIG. 2 is a flowchart 200 depicting a process for calibrating the DQ and RQ links of memory system 100 in accordance with one embodiment. In this example, fine and coarse calibration will be described as occurring sequentially. To begin fine calibration, controller 105 initiates calibration (step 205) by issuing a calibration command Cal via control interface 115. Upon receipt of the command, memory 110 enters a calibration mode (step 210), and begins sending test patterns PattA (step 212) from pattern generator 155 over data links DQ[31:0] and request links RQ[3:0]. Controller 105 then tunes, in step 220, the receive phases of the controller's request and data interface blocks with reference to a receive clock (not shown). Such tuning can be accomplished by selectively delaying request and data signals relative to a clock signal or vice versa using conventional phase-adjustment circuitry. Methods and circuits for phase aligning clock signals with received signals are well known to those of skill in the art, and are therefore omitted here for brevity. Mode register 165 can direct dummy address generator 150 to simulate noise during this fine calibration. In this example, coarse calibration of the controller's links occurs after the receive phases of the test patterns are aligned. Dummy address generator 150 can be used to simulate noise during coarse calibration.

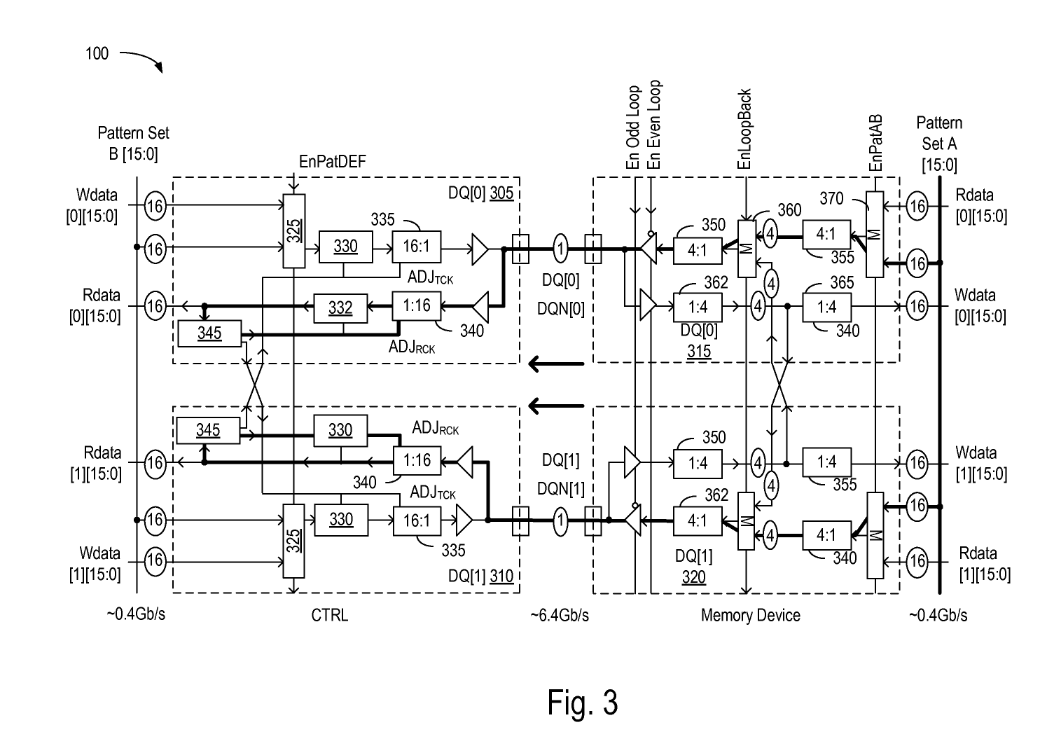

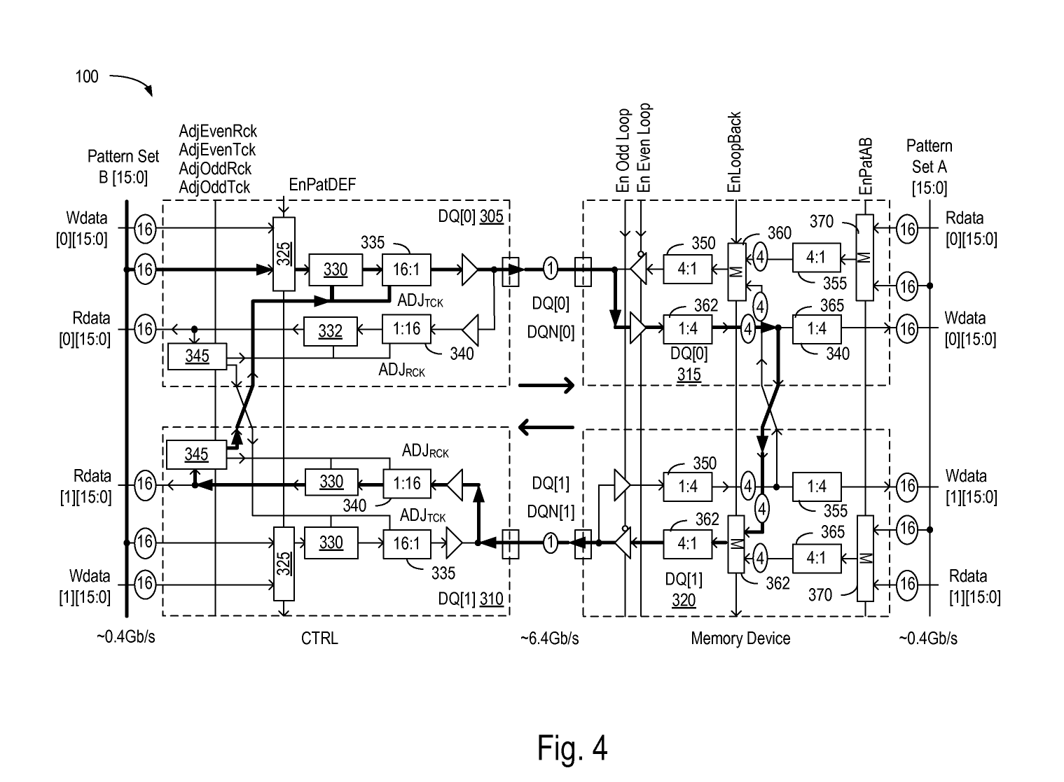

In the next step 225, controller 105 issues a loop-back command to memory device 110 via control interface 115. The loop-back command causes the data and request interfaces in memory 110 to enter a “loop-back” mode in which signals conveyed to memory device 110 via these high-speed interfaces are immediately returned to controller 105 (step 230). In one embodiment, each even-numbered data and request link is looped back via an adjacent odd-numbered link. For example, the data link for DQ[0] may be looped back at the memory side of system 100 via the data link for DQ[1]. Once in the loop-back mode, controller 105 conveys test patterns PattA from pattern generator 125 (step 232) to memory device 110 via the even links, and memory device 110 returns the test patterns PattB via the odd links (step 240). Having thus calibrated the odd return links, controller 105 repeats the process is repeated with the even and odd links reversed. Circuits for looping back data and request signals are detailed below in connection with FIGS. 3 and 4.

Controller 105, upon receiving the returned test patterns PattB, compares them with the originally transmitted patterns and fine tunes the transmit phases of the data and request signals (step 250). Because the return links are already calibrated, errors can be attributed to issues in the forward links (toward memory device 110). Also in step 250, coarse tuning (bit level) is used to align the data patterns once the phases are appropriately timed.

In this embodiment the request links (RQ[3:0]) employ the same bidirectional interface circuitry as the data links, and can thus be tuned in the same fashion as the data links. In alternative embodiment, loop-back paths from request links to data links may be included at the memory device for embodiments in which the request links are unidirectional. Request links that operate at lower speeds may not require the same degree of tuning as the data links.

A bidirectional link can be calibrated without loop back by writing test patterns to memory over the link and reading back the test patterns over the same or a different link. Such a process is far slower than a loop-back process, however, as controller 105 must await the completion of write and read cycles prior to making an adjustment based upon the received pattern. Furthermore, the RQ links may not support a path back to controller 105.

With the forward and return links thus calibrated, controller 105 directs memory 110 through a margin-test and calibration sequence. This sequence tests the voltage and timing margins of the request and data links, tests the read and write capability of the memory, and provides additional timing calibration for the request and data links if needed. As noted previously, exercising memory 110 requires controller 105 to issue read and write commands over request lines RQ[3:0]. These exercises explore error margins for the request and data signals by purposefully advancing and retarding signal phases to deliberately introduce sample errors. Errors in sampling request signals could cause memory 110 to perform potentially disruptive operations, such as powering down the memory. Controller 105 thus issues a command via interface 115 instructing filter 140 to decline potentially harmful commands (step 255). Responsive to the filter command, control logic 135 loads mode register 165 with a filter-mode value that enables filter 140 (step 260). Filter 140, when enabled, can decline a command from a restricted group of commands by blocking the command or by converting the restricted command to an allowed command. In one embodiment, for example, enabled filter 140 converts any restricted commands into a “NOP” (for “no operation”) command. The NOP command can then be conveyed to one or both of two row/column decoders Dec0/1 associated the respective memory banks but the decoders take no action.

Flowchart 200 represents the subsequent tests using a “for-loop” shared between controller 105 and memory 110, and beginning with node 262. The for-loop executes the steps between its terminating nodes 262 and 285 until each of a series of request and data tests are completed. The test and calibration sequence of the for-loop reads and writes data using different phase offsets to sweep the request and data timing across one unit interval. This allows controller 105 to further refine the initial transmit and receive phases derived in the prior calibration sequences. For each test, controller 105 transmits requests or requests and data (265) to memory 110. Filter 140 determines whether a given command is one of the filtered set (decision 270). If so, the command associated with the request is converted to a NOP command before being conveyed to one of decoders Dec0/1 via switching logic 145 (step 275). The NOP is “performed” in step 280, though performance in this event means to do nothing. If decision 270 determines the command to be one of the allowed set, then the request is carried out in step 280. The requested operations provide controller 105 the requisite feedback for tuning the RQ and DQ links, which is indicated by the end of the for-loop 285.

The test and calibration sequence of flowchart 200 ends when system 100 is calibrated. Controller 105 then enters, and commands memory 110 to enter, the operational mode (step 290). Memory 110 loads the appropriate value into mode register 165 responsive to the command (step 295). Among other things, this command disable filter 140 to allow controller 105 to issue a full range of requests to memory 110. Controller 105 thereafter writes to and reads from memory 110, e.g. in the service of a CPU (not shown). The calibration sequence, or portions thereof, can be repeated periodically to accommodate changes in e.g. temperature and supply voltage. Other than the filtering of certain commands, the test and calibration sequence of flowchart 200 is conventional. Implementation details will vary from system to system, as will be understood by those of skill in the art. A detailed discussion is omitted or brevity.

An embodiment of memory system 100 supports the command set listed in Table 1, a subset of which is filtered out in decision 270 when system 100 is in the calibration mode. In brief, filter 140 selectively blocks requests that include a power-transition command, a control-register-load command, or a burst command. When filter 140 is engaged, the allowed commands permit full address-field variability, which is important in creating inter-symbol interference (ISI) and crosstalk representative of those encountered in an operational mode.

TABLE 1

| | | Filtered |
|---|---|---|
| Command | Description | Out? |
| NCK | No clock enable | No |
| NOP | No operation | No |
| ACT | Activate: select bank B and activate row R | No |
| RD | Read: select bank B and column C, and | No |
| | start read burst | |
| RDA | Read-Autoprecharge: select bank B and | No |
| | column C, start read burst, and finish with | |
| | autoprecharge | |
| WR | Write: select bank B and column C, and | No |
| | start write burst. | |
| WRA | Row activate operation. | No |
| WRM | Write-Autoprecharge: select bank B and | No |
| | column C, start write burst, and finish with | |
| | autoprecharge. | |
| PRE | Precharge: precharge row in selected bank B. | No |
| PRA | Precharge All: precharge row in all banks. | No |
| BST | Burst-Terminate: halts a column access | No |
| | (read or write) before the end of an access. | |
| DPD | Deep Power-Down: the power state in | Yes |
| | which most of the memory component is | |
| | shut down (disabled). A small amount of | |
| | circuitry remains active to perform self- | |
| | refresh of the core (an oscillator, a row | |
| | address counter, a bank address counter, | |
| | and a state machine). | |
| ARF | Auto-Refresh: the operation used in normal | Yes |
| | (active) mode to perform core refresh. | |
| | Auto-Refresh is invoked by an ARF | |
| | command interspersed between other core | |
| | commands (activate, precharge, read, and | |
| | write). | |
| SRF | Self-Refresh: a small amount of circuitry | Yes |
| | remains active to perform self-refresh of | |
| | the core (an oscillator, a row address | |
| | counter, a bank address counter, and a state | |
| | machine). | |
| MRS | Mode Register Set: used to set the fields of | Yes |
| | the control registers to enable different | |
| | options or modes. | |

Specific example circuitry to support the above-described test procedures will now be described. The following FIGS. 3 and 4 detail aspects of an embodiment of memory system 100 of FIG. 1 in which the DQ and RQ links include loop-back connectivity in support of write calibration.

FIG. 3 details portions of system 100 of FIG. 1, two controller-side data interfaces 305 and 310 and the corresponding two memory-device-side data interfaces 315 and 320. Each controller-side data interface includes a test multiplexer 325, two leveling circuits 330 and 332, a serializer 335, a deserializer 340, and match circuitry 345. With reference to data interface 305, multiplexer 325 selects either sixteen write-data bits Wdata or a sixteen-bit pattern from e.g. pattern generator 125 of FIG. 1 (the role of multiplexers 325 is played by multiplexer 120 in FIG. 1). The output from multiplexer 325 is coupled to one of two leveling circuits 330 and 332. Each leveling circuit 330 and 332 is used to coarsely align received and expected test patterns on a per-bit basis using known techniques. Serializer 335, e.g. a multiplexer, then converts the resulting sixteen-bit data into serial data for transmission to interface 316.

In the depicted example, a 400 MHz clock is distributed to both the controller and the memory device to synchronize their respective cores (not shown), and the data and request signals are conveyed serially at 6.4 Gb/s using appropriately timed transmit and receive clocks. Methods and circuits for generating and distributing suitable clock signals, and for sweeping clock phases to correctly capture data, are known. Detailed discussions of clock generation, distribution, and alignment are therefore omitted for brevity.

On the receive side of data link DQ[0], a one-to-sixteen 340 deserializer converts received serial data into sixteen-bit data, which is conveyed to leveling circuit 332. When the memory device is operational, received data Rdata is ultimately conveyed to the core logic. In the calibration mode, match circuitry 345 examines received test data Rdata against expected patterns and issues phase control signals to serializer 340, leveling circuit 332, and deserializer 335 of neighboring interface 310. Interface 310 has similar components and works in a similar fashion.

Write interface 315 on the memory side includes two four-to-one serializers 350 and 355, loop-back select logic (a multiplexer) 360, two one-to-four deserializers 362 and 365, and a pattern-enable multiplexer 370. In the calibration mode, responsive to an enable-pattern signal EnPattAB, multiplexer 370 directs patterns from pattern generator 155 (FIG. 1) to deserializer 340, which necks down the sixteen bits from pattern bus PatternSetA to four bits. Multiplexer 360 conveys the resulting test patterns to serializer 350, which produces a serial data stream to interface 305 of the memory controller. Of two enable signals EnOddLoop and EnEvenLoop, the latter enables the input and output buffers of interface 315 (DQ[0] is considered an “even” link, and DQ[1] an odd). Interface 320 has similar components and works in a similar fashion, though the input and output buffers are controlled by enable signal EnOddLoop. A detailed treatment of interface 320 is omitted for brevity.

With reference to the upper interface pair, the test patterns traverse both interfaces 315 and 305, ultimately arriving at match circuit 345. Match circuit 345, which may be implemented in hardware or using a combination of hardware and software, manipulates phase-adjust signal ADJRCK, and consequently the input phase of deserializer 340, until the deterministic patterns from interface 315 are as expected. In a typical example, match circuit 345 might scan the phase of the receive clock with respect to an external reference clock to find the phase offset centered within a range of phase values that produces correctly sampled data. Signal characteristics other than phase can be adjusted as well (e.g., termination values, drive strength, and equalization parameters). In embodiments that support high-speed RQ links, the phase and signal characteristics adjusted in the DQ links may also require adjustment in the RQ links. Match circuit 345 then stores the resulting phase value for the link. Interface 310 is likewise phase calibrated at the same time. The RQ links are identical to the DQ links in the embodiment of FIG. 1, so the foregoing description applies equally to the RQ links.

FIG. 4 depicts the configuration process for an “even” write link of system 100 in the loop-back mode. Multiplexer 360 in interface 320 on the memory-device side selects the output from deserializer 362 of interface 315. Patterns conveyed in the write direction from interface 305 are therefore fed back to interface 310, and ultimately to pattern matching circuit 345 of link 310. Because the read channels were tuned as noted previously in connection with FIG. 3, errors noted by matching circuit 345 are attributable to the write channel. This process is sometimes referred to as “write-launch” calibration, in which the transmit phase of write data is calibrated with respect to a reference clock. Pattern match circuitry sweeps the phase of the transmit clock via a transmit-clock-adjust signal ADJTCK in the same manner described previously for the receive clock, ultimately arriving at a phase setting that provides a desired error rate. The process can then be repeated for the odd write links using the even read links for the loop-back channel.

In this example, all the even links are tuned together, followed by all the odd links. The request links are bidirectional, and can be tuned in the same way. Other embodiments may have unidirectional RQ links, in which case request interfaces on the memory device can be modified to use e.g. a neighboring DQ link for loop-back testing. Once all the read and write links are tuned, the system can repeat the calibration in an artificial noise environment using dummy core operations for fine tuning.

Memory controller 105 may include integrated steering logic to manage the flow of requests for different numbers of memories 110. In other embodiments, the steering logic for the memory controller can be external to the controller IC, and steering logic shown here as being within each memory IC can likewise be provided externally. Also, while the command interface includes separate sub-interfaces for low-speed control signals and high-speed request in the exemplary embodiments, a single interface can be used for both types of commands in other embodiments. For example, the request interface can support a robust, low-speed mode to issue pre-calibration commands needed to calibrate the links as required to convey requests and data at higher speeds. The control interface can also be implemented using e.g. common-mode signaling over the same conductors as request interface 107.

An output of a process for designing an integrated circuit, or a portion of an integrated circuit, comprising one or more of the circuits described herein may be a computer-readable medium such as, for example, a magnetic tape or an optical or magnetic disk. The computer-readable medium may be encoded with data structures or other information describing circuitry that may be physically instantiated as an integrated circuit or portion of an integrated circuit. Although various formats may be used for such encoding, these data structures are commonly written in Caltech Intermediate Format (CIF), Calma GDS II Stream Format (GDSII), or Electronic Design Interchange Format (EDIF). Those of skill in the art of integrated circuit design can develop such data structures from schematic diagrams of the type detailed above and the corresponding descriptions and encode the data structures on computer readable medium. Those of skill in the art of integrated circuit fabrication can use such encoded data to fabricate integrated circuits comprising one or more of the circuits described herein.

In the foregoing description and in the accompanying drawings, specific terminology and drawing symbols are set forth to provide a thorough understanding of the foregoing embodiments. In some instances, the terminology and symbols may imply specific details that are not required to practice the invention. Furthermore, the term “system” may refer to a complete communication system, including a transmitter and a receiver, or may refer to portion of a communication system, such as a transmitter, a receiver, or an IC or other component that includes a transmitter and/or receiver. Still other embodiments will be evident to those of skill in the art. Moreover, while some components are shown directly connected to one another while others are shown connected via intermediate components. In each instance the method of interconnection, or “coupling,” establishes some desired electrical communication between two or more circuit nodes (e.g., pads, lines, or terminals). Such coupling may often be accomplished using a number of circuit configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. §112.

What is claimed is:

1. A memory controller supporting a plurality of memory-access commands and a filter command, the memory-access commands including at least one of a power-transition command, a control-register-load command, and a burst command, the memory controller comprising:
a command interface to convey the memory-access commands and filter command to a memory device; and
controller logic coupled to the command interface to issue the memory-access commands and filter command, wherein the filter command is to instruct the memory device to decline at least one of the power-transition command, the control-register-load command, and the burst command.

2. The memory controller of claim 1, wherein the command interface includes a request interface to convey the memory-access commands and a control interface to convey the filter command.

3. The memory controller of claim 2, wherein the request interface operates at a first rate and the control interface operates at a second rate lower than the first rate.

4. The memory controller of claim 1, further comprising a data interface to convey data between the memory controller and the memory device at a data rate equal to the first rate.

5. A memory device comprising:
a memory bank to store data;
a data interface coupled to the memory bank to transmit and receive the data;
a command interface to receive memory-access commands and a filter command, the memory-access commands including at least one of a power-transition command, a control-register-load command, and a burst command; and
a command filter coupled to the command interface to selectively decline at least one of the power-transition command, the control-register-load command, and the burst command responsive to the filter command.

6. The memory device of claim 5, wherein the command interface includes a request interface to receive the memory-access commands and a control interface to receive the filter command.

7. The memory device of claim 6, wherein the request interface operates at a first rate and the control interface operates at a second rate lower than the first rate.

8. The memory device of claim 5, wherein the data interface transmits and receives the data at a data rate and the request interface operates at a request rate equal to the data rate.

9. The memory device of claim 5, further comprising a mode register to store a filter-mode value responsive to the filter command.

10. The memory device of claim 5, wherein declining the at least one of the power-transition command, the control-register-load command, and the burst command comprises issuing a no-operation command.

11. The memory device of claim 5, wherein the command filter ignores the at least one of the power-transition command, the control-register-load command and the burst command in response to the filter command.

12. A method of testing a memory device adapted to respond to a plurality of memory-access commands, including at least one of a power-transition command, a control-register-load command, and a burst command, the method comprising:
storing a filter command at the memory device;
receiving at least one of the power-transition command, the control-register-load command, and the burst command as a received command; and
declining the received command responsive to the filter command.

13. The method of claim 12, wherein storing the filter command comprising loading a mode register on the memory device.

14. The method of claim 12, wherein receiving the received command comprises misinterpreting a transmitted command from a memory controller.

15. The method of claim 12, wherein the memory device receives the filter command at a command rate and receives the received command at a command rate higher than the command rate.

16. The method of claim 12, wherein the memory device receives data at a data rate and receives the received command at the data rate.

17. A memory die comprising:
a register to store a filter command;
means for receiving at least one of a power-transition command, a control-register-load command, and a burst command; and
means for declining the received command responsive to the filter command.

18. The memory die of claim 17, wherein the means for declining the received command issues a second command responsive to the received command.

19. A memory system comprising:
a memory controller supporting a plurality of memory-access commands and a filter command, the memory-access commands including at least one of a power-transition command, a control-register-load command, and a burst command, the memory controller including a command interface to convey the memory-access commands and filter command; and
a memory device coupled to the memory controller via the command interface and a data interface, the memory device including a memory bank to store data, a command interface to receive the memory-access commands and the filter command from the memory controller; and a command filter coupled to the command interface to selectively decline at least one of the power-transition command, the control-register-load command, and the burst command responsive to the filter command.

20. A computer-readable medium having stored thereon a data structure defining an integrated memory device, the data structure comprising:
first data representing a memory bank;
second data representing a first interface coupled to the memory bank to read to an write from the memory bank;
third data representing a command interface to receive memory-access commands and a filter command, the memory-access commands including at least one of a power-transition command, a control-register-load command, and a burst command; and
fourth data representing a command filter coupled to the command interface to selectively decline at least one of the power-transition command, the control-register-load command, and the burst command responsive to the filter command.

21. The memory device of claim 20, wherein declining the at least one of the power-transition command, the control-register-load command, and the burst command comprises issuing a no-operation command.

22. The memory device of claim 20, wherein the command filter ignores the at least one of the power-transition command, the control-register-load command and the burst command in response to the filter command.
